(19) United States
(12) Patent Application Publication
(10) Pub. No.: US 2025/0210823 A1
(43) Pub. Date: Jun. 26, 2025

(54) BUS BAR MODULE

(71) Applicant: YAZAKI CORPORATION, Tokyo (JP)

(72) Inventors: Katsunori Sato, Makinohara-shi (JP); Tatsuya Oga, Makinohara-shi (JP); Mariko Nakagawa, Makinohara-shi (JP); Masato Tanaka, Makinohara-shI (JP)

(21) Appl. No.: 18/976,346

(22) Filed: Dec. 11, 2024

(30) Foreign Application Priority Data
Dec. 25, 2023 (JP) 2023-218338

(51) Int. Cl. H01M 50/519; H01M 50/507

(52) U.S. Cl. CPC H01M 50/519; H01M 50/507

(57) ABSTRACT

A bus bar module includes: bus bar group including a plurality of bus bars arranged at intervals along an arrangement direction; and a plurality of detection lines connected to the bus bars of the bus bar group, in which at least one detection line among the plurality of detection lines includes a first portion, a second portion, and a third portion wired between two adjacent ones of the bus bars to connect the first portion and the second portion, the first portion is wired on a first side with respect to the bus bar group in a width direction orthogonal to the arrangement direction when the bus bar group is viewed in a plan view, and the second portion is wired on a second side with respect to the bus bar group in the width direction.

### CROSS-REFERENCE TO RELATED APPLICATION(S)

The present application claims priority to and incorporates by reference the entire contents of Japanese Patent Application No. 2023-218338 filed in Japan on Dec. 25, 2023.

### BACKGROUND OF THE INVENTION

### 1. Field of the Invention

The present invention relates to a bus bar module.

### 2. Description of the Related Art

Conventionally, there are a unit and a module assembled to a battery assembly. Japanese Patent Application Laid-open No. 2018-55843 discloses a battery monitoring unit including a plurality of voltage detection lines of which one end portions are connected to a plurality of bus bars arranged in parallel in a stacking direction of unit cells, respectively, and a flexible printed circuit that extends in the stacking direction of the unit cells with the plurality of voltage detection lines arranged thereon.

From the viewpoint of reducing a size of a battery pack, there has been a demand for reducing a height of a bus bar module. When a plurality of detection lines to be connected to bus bars are arranged, if the overcrowding of the detection lines can be suppressed, the height of the bus bar module can be reduced.

### SUMMARY OF THE INVENTION

An object of the present invention is to provide a bus bar module capable of suppressing the overcrowding of detection lines.

In order to achieve the above mentioned object, a bus bar module according to one aspect of the present invention includes a bus bar group including a plurality of bus bars arranged at intervals along an arrangement direction; and a plurality of detection lines connected to the bus bars of the bus bar group, wherein at least one detection line among the plurality of detection lines includes a first portion, a second portion, and a third portion wired between two adjacent ones of the bus bars to connect the first portion and the second portion, the first portion is wired on a first side with respect to the bus bar group in a width direction orthogonal to the arrangement direction when the bus bar group is viewed in a plan view, and the second portion is wired on a second side with respect to the bus bar group in the width direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view of a bus bar module according to an embodiment;

FIG. 2 is a plan view of another bus bar module according to an embodiment;

FIG. 3 is a plan view of another bus bar module according to an embodiment; and

FIG. 4 is a plan view of another bus bar module according to an embodiment.

### DETAILED DESCRIPTION OF THE PREFERRED EMBODIMENTS

Hereinafter, bus bar modules according to embodiments of the present invention will be described in detail with reference to the drawings. Note that the present invention is not limited by the present embodiments. In addition, the components in the following embodiments include those that can be easily imagined by those skilled in the art or those that are substantially the same.

Embodiments

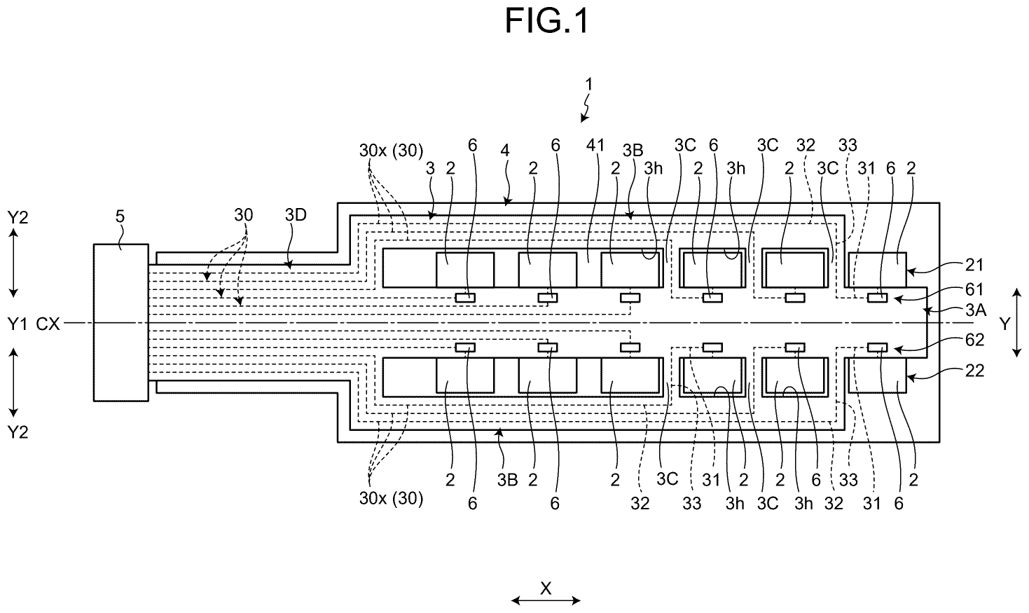

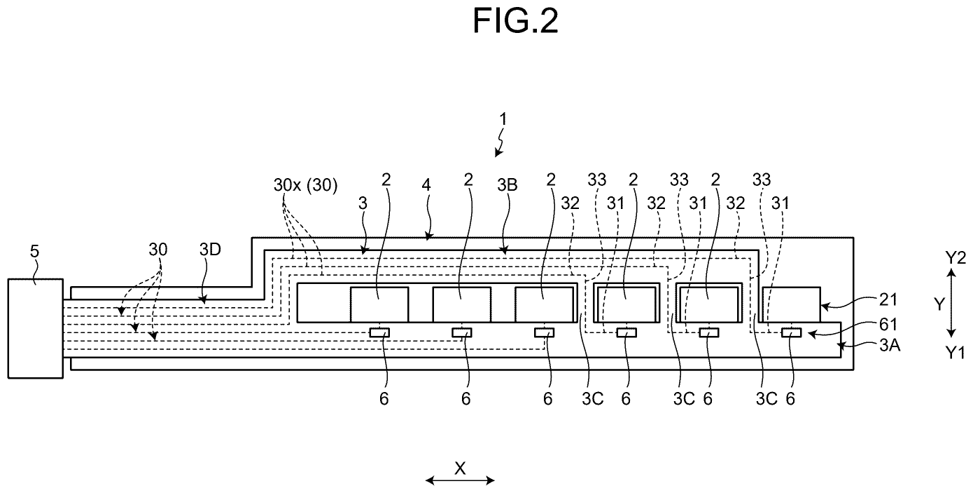

Embodiments will be described with reference to FIGS. 1 to 4. The present embodiments relate to bus bar modules. FIG. 1 is a plan view of a bus bar module according to an embodiment, and FIGS. 2 to 4 are plan views of other bus bar modules according to embodiments.

As illustrated in FIG. 1, a bus bar module 1 of the present embodiment includes a plurality of bus bars 2, a flat wiring member 3, a case 4, and a connector 5. The bus bar module 1 is assembled to, for example, a battery module having a plurality of battery cells. The bus bar 2 is a plate-like member formed of a conductive metal. The bus bar 2 is fixed to, for example, an electrode of a battery cell, and electrically connects two battery cells. The plurality of bus bars 2 are arranged at intervals along an arrangement direction X. The arrangement direction X is, for example, a direction in which the battery cells are arranged in the battery module.

The bus bar module 1 of the present embodiment includes a first bus bar group 21 and a second bus bar group 22. Each of the first bus bar group 21 and the second bus bar group 22 includes a plurality of bus bars 2 arranged in the arrangement direction X. The first bus bar group 21 and the second bus bar group 22 are arranged in a width direction Y orthogonal to the arrangement direction X. The width direction Y is a direction orthogonal to the arrangement direction X when the plurality of bus bars 2 are viewed in a plan view.

The flat wiring member 3 is a wiring member having a flat shape. The flat wiring member 3 in FIG. 1 is a flexible printed circuit (FPC). The FPC includes a base film, a conductive layer, and a cover layer. The conductive layer is sandwiched between and protected by the base film and the cover layer. The conductive layer is, for example, a conductive metal foil, and has a circuit pattern including a plurality of detection lines 30. The flat wiring member 3 has flexibility and can be bent when being wired.

The bus bar module 1 of the present embodiment includes a plurality of chip fuses 6 mounted on the flat wiring member 3. The chip fuse 6 is disposed near the corresponding bus bar 2. More specifically, the plurality of chip fuses 6 includes a first fuse group 61 and a second fuse group 62. The chip fuses 6 of the first fuse group 61 are connected to the bus bars 2 of the first bus bar group 21. The chip fuses 6 of the second fuse group 62 are connected to the bus bars 2 of the second bus bar group 22.

The chip fuses 6 of the first fuse group 61 are arranged in a line along the arrangement direction X. The first fuse group 61 is disposed on a first side Y1 in the width direction Y with respect to the first bus bar group 21. The first side Y1 in the width direction Y is, for example, a side toward a center line CX with respect to the bus bar 2. The center line CX is a center line of the bus bar module 1, and is a straight line in the arrangement direction X. The center line CX is, for example, an intermediate line between the first bus bar group 21 and the second bus bar group 22. With respect to the bus bars 2 of the first bus bar group 21, the first side Y1 in the width direction Y is a side toward the second bus bar group 22. With respect to the bus bars 2 of the first bus bar group 21, a second side Y2 in the width direction Y is opposite to the side toward the center line CX. In other words, with respect to the first bus bar group 21, the second side Y2 is a side opposite to the side toward the second bus bar group 22.

Each detection line 30 is connected to the bus bar 2 via the chip fuse 6. For example, the detection lines 30 corresponding to the first bus bar group 21 are connected to the bus bars 2 of the first bus bar group 21 via the chip fuses 6 of the first fuse group 61. The detection lines 30 corresponding to the second bus bar group 22 are connected to the bus bars 2 of the second bus bar group 22 via the chip fuses 6 of the second fuse group 62.

In the detection line 30, an end portion on a side opposite to a side connected to the bus bar 2 is connected to the connector 5. The connector 5 is disposed at an end portion of the flat wiring member 3. The connector 5 has a plurality of terminals connected to the detection lines 30. The plurality of detection lines 30 are connected to an external device via the connector 5. The external device is, for example, a monitoring device that monitors the state of the battery module.

As illustrated in FIG. 1, at least one detection line 30 among the plurality of detection lines 30 has a first portion 31, a second portion 32, and a third portion 33. The first portion 31 and the second portion 32 are wired on different sides in the width direction Y with respect to the plurality of bus bars 2. In the bus bar module 1 of FIG. 1, the first portion 31 is wired on the first side Y1 in the width direction Y with respect to the plurality of bus bars 2 arranged in a line in the arrangement direction X. In this case, the second portion 32 is wired on the second side Y2 in the width direction Y with respect to the plurality of bus bars 2. The third portion 33 is a portion wired between two adjacent bus bars 2 to connect the first portion 31 and the second portion 32. The third portion 33 extends along the width direction Y.

In the following description, the detection line 30 having the first portion 31, the second portion 32, and the third portion 33 will be referred to as predetermined detection line 30x. In the flat wiring member 3 of the present embodiment, the detection lines 30 connected to the bus bars 2 of the first bus bar group 21 include predetermined detection lines 30x, and the detection lines 30 connected to the second bus bar group 22 also include predetermined detection lines 30x.

In the bus bar module 1 of the present embodiment, the plurality of detection lines 30 include predetermined detection lines 30x. As a result, in the bus bar module 1 of the present embodiment, the height of the bus bar module 1 can be reduced. As a comparative example, there is a bus bar module in which all detection lines are arranged on the first side Y1 with respect to the plurality of bus bars 2, or a bus bar module in which all detection lines are arranged on the second side Y2 with respect to the plurality of bus bars 2. In the bus bar module of the comparative example, since all the detection lines are concentrated in one region, it is difficult to reduce the height of the bus bar module. For example, in the FPC, the conductive layer may be multi-layered, which may increase the thickness of the flat wiring member.

In the bus bar module 1 of the present embodiment, it is possible to wire the plurality of detection lines 30 in such a manner as to be distributed to the first side Y1 and the second side Y2 with respect to the bus bars 2. As a result, the height of the bus bar module 1 can be reduced. In addition, in the bus bar module 1 of the present embodiment, the third portions 33 are each wired between the two bus bars 2. As a result, it is possible to reduce the space required for wiring. For example, in the FPC, if the third portions 33 are disposed to detour further toward the second side Y2 than the bus bars 2 at end portions of the bus bar groups 21 and 22, the area of the FPC increases. In contrast, in the bus bar module 1 of the present embodiment, the size of the FPC is reduced by effectively using a region between the bus bars 2 as a space for wiring the third portion 33.

As illustrated in FIG. 1, the flat wiring member 3 includes a first region 3A, a second region 3B, and a third region 3C. The first region 3A is a region where the first portions 31 of the detection lines 30 are formed. The first region 3A is disposed on the first side Y1 in the width direction Y with respect to the bus bar 2. The second region 3B is a region where the second portions 32 of the detection lines 30 are formed. The second region 3B is disposed on the second side Y2 in the width direction Y with respect to the bus bar 2. The third region 3C is a region where the third portions 33 of the detection lines 30 are formed. The third region 3C is disposed between two adjacent bus bars 2. The third region 3C connects the first region 3A and the second region 3B along the width direction Y.

The flat wiring member 3 has an opening 3h through which the bus bar 2 is exposed. The opening 3h has a rectangular shape. The flat wiring member 3 of FIG. 1 has a plurality of openings 3h arranged in the arrangement direction X. Among the plurality of detection lines 30, some detection lines 30 do not have second portions 32. In FIG. 1, the detection lines 30 connected to the bus bars 2 on the side closer to the connector 5 in the first bus bar group 21 do not have second portions 32 and third portions 33. On the other hand, the detection lines 30 connected to the bus bars 2 on the side far from the connector 5 have second portions 32 and third portions 33.

Similarly, the detection lines 30 connected to the bus bars 2 on the side closer to the connector 5 in the second bus bar group 22 do not have second portions 32 and third portions 33. The detection lines 30 connected to the bus bars 2 on the side far from the connector 5 in the second bus bar group 22 have second portions 32 and third portions 33. With such wiring, the concentration of the detection lines 30 in the region between the two bus bar groups 21 and 22 is mitigated.

The flat wiring member 3 of FIG. 1 has an end portion 3D connected to the connector 5. The first region 3A and the two second regions 3B are branched from the end portion 3D. All the detection lines 30 are connected to the connector 5 through the end portion 3D. The predetermined detection lines 30x are arranged on the second side Y2 in the width direction Y in the end portion 3D. The detection lines 30 excluding the predetermined detection lines 30x are arranged on the first side Y1 in the width direction Y in the end portion 3D.

The case 4 accommodates the plurality of bus bars 2 and the flat wiring member 3. The case 4 has, for example, a substantially rectangular shape. The case 4 has a support wall 41 that supports the bus bar 2. The support wall 41 has a through hole disposed at a position facing the bus bar 2. The bus bar 2 is connected to the electrode of the battery cell via the through hole.

Note that the bus bar module of FIG. 1 may include a plurality of connectors 5. For example, in the bus bar module 1, the connector 5 to which the predetermined detection lines 30x are connected and the connector 5 to which the detection lines 30 excluding the predetermined detection lines 30x are connected may be different connectors. In this case, the first region 3A and the second region 3B of the flat wiring member 3 may be connected to the different connectors 5, respectively, without being joined together at the end portion 3D.

FIG. 2 illustrates another bus bar module 1 according to an embodiment. The bus bar module 1 of FIG. 2 is different from the bus bar module 1 of FIG. 1 in that, for example, there is a one-row bus bar group. The bus bar module 1 of FIG. 2 includes a first bus bar group 21 linearly arranged along the arrangement direction X. A first fuse group 61 corresponding to the first bus bar group 21 is mounted on the flat wiring member 3. The first fuse group 61 is disposed on the first side Y1 in the width direction Y with respect to the plurality of bus bars 2. The first fuse group 61 is linearly arranged in a line along the arrangement direction X. Each detection line 30 is connected to the bus bar 2 via the chip fuse 6.

Among the plurality of detection lines 30 connected to the first bus bar group 21, at least one detection line 30 is a predetermined detection line 30x having a first portion 31, a second portion 32, and a third portion 33. In the bus bar module 1 of FIG. 2, the predetermined detection lines 30x are detection lines 30 connected to the bus bars 2 on the side far from the connector 5. The first portions 31 are wired on the first side Y1 in the width direction Y with respect to the plurality of bus bars 2. The second portions 32 are wired on the second side Y2 in the width direction Y with respect to the plurality of bus bars 2. The third portions 33 are each wired between two adjacent bus bars 2 to connect the first portions 31 and the second portions 32.

In the bus bar module 1 of FIG. 2, the detection lines 30 connected to the bus bars 2 on the side closer to the connector 5 do not have second portions 32 and third portions 33. The flat wiring member 3 of FIG. 2 has a first region 3A, a second region 3B, a third region 3C, and an end portion 3D connected to the connector 5. The first region 3A is a region where the first portions 31 of the detection lines 30 are formed. The second region 3B is a region where the second portions 32 of the detection lines 30 are formed. The third region 3C is a region where the third portions 33 of the detection lines 30 are formed.

The first region 3A and the second region 3B are branched from the end portion 3D. All the detection lines 30 are connected to the connector 5 through the end portion 3D. The predetermined detection lines 30x are arranged on the second side Y2 in the width direction Y in the end portion 3D. The detection lines 30 excluding the predetermined detection lines 30x are arranged on the first side Y1 in the width direction Y in the end portion 3D. The plurality of bus bars 2 and the flat wiring member 3 are accommodated in the case 4.

The bus bar module 1 of FIG. 2 is assembled to the battery module, for example, in combination with another bus bar module forming a pair. In this case, the bus bars 2 of the bus bar module 1 of FIG. 2 are connected to electrodes in one row of the battery module. The bus bars of the other bus bar module are connected to electrodes in the other row of the battery module.

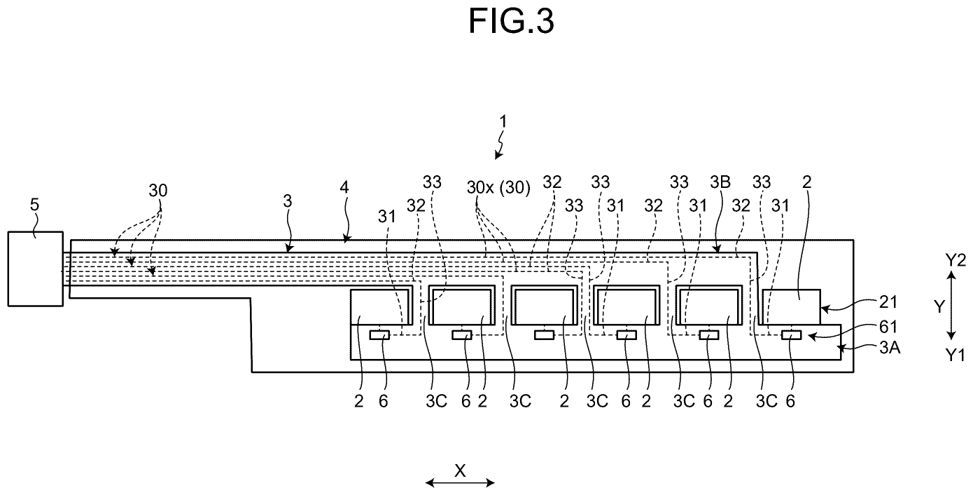

FIG. 3 illustrates another bus bar module 1 according to an embodiment. The bus bar module 1 of FIG. 3 is different from the bus bar module 1 of FIG. 2 in that, for example, all the detection lines 30 are predetermined detection lines 30x. A first fuse group 61 corresponding to the first bus bar group 21 is mounted on the flat wiring member 3. The first fuse group 61 is disposed on the first side Y1 in the width direction Y with respect to the plurality of bus bars 2. The first fuse group 61 is linearly arranged in a line along the arrangement direction X.

In the flat wiring member 3 of FIG. 3, all the detection lines 30 connected to the first bus bar group 21 are predetermined detection lines 30x. That is, all the detection lines 30 connected to the bus bars 2 have second portions 32 and third portions 33. The first portions 31 are wired on the first side Y1 in the width direction Y with respect to the plurality of bus bars 2. The second portions 32 are wired on the second side Y2 in the width direction Y with respect to the plurality of bus bars 2. The third portions 33 are each wired between two adjacent bus bars 2 to connect the first portions 31 and the second portions 32.

The flat wiring member 3 of FIG. 3 has a first region 3A, a second region 3B, a third region 3C, and an end portion 3D connected to the connector 5. A plurality of third portions 33 may be formed in the third region 3C. In the flat wiring member 3 of FIG. 3, two third portions 33 are formed in the third region 3C located at the center in the arrangement direction X. The first region 3A and the second region 3B are branched from the end portion 3D. All the detection lines 30 are connected to the connector 5 through the end portion 3D. The plurality of bus bars 2 and the flat wiring member 3 are accommodated in the case 4.

The bus bar module 1 of FIG. 3 is assembled to the battery module, for example, in combination with another bus bar module forming a pair. In this case, the bus bars 2 of the bus bar module 1 of FIG. 3 are connected to electrodes in one row of the battery module. The bus bars of the other bus bar module are connected to electrodes in the other row of the battery module.

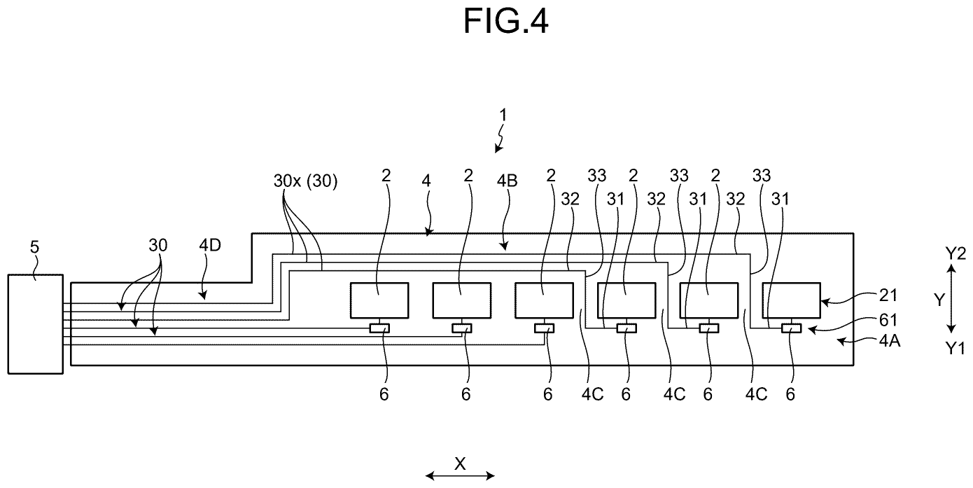

The detection lines 30 are not limited to the circuit pattern of the FPC, and may be, for example, electric wires. FIG. 4 illustrates a bus bar module 1 in which electric wires are used as the detection lines 30. The bus bar module 1 of FIG. 4 includes a plurality of bus bars 2, a plurality of detection lines 30, a case 4, and a connector 5. The bus bar module 1 of FIG. 4 includes a first bus bar group 21 linearly arranged along the arrangement direction X. The first fuse group 61 is disposed on the first side Y1 in the width direction Y with respect to the plurality of bus bars 2. Each chip fuse 6 may be fixed to the corresponding bus bar 2. Each detection line 30 is connected to the bus bar 2 via the chip fuse 6.

Among the plurality of detection lines 30 connected to the first bus bar group 21, at least one detection line 30 is a predetermined detection line 30x. The predetermined detection line 30 has a first portion 31, a second portion 32, and a third portion 33. In the bus bar module 1 of FIG. 4, the predetermined detection lines 30x are detection lines 30 connected to the bus bars 2 on the side far from the connector 5. The first portions 31 are wired on the first side Y1 in the width direction Y with respect to the plurality of bus bars 2. The second portions 32 are wired on the second side Y2 in the width direction Y with respect to the plurality of bus bars 2. The third portions 33 are each wired between two adjacent bus bars 2 to connect the first portions 31 and the second portions 32. In the bus bar module 1 of FIG. 4, the detection lines 30 connected to the bus bars 2 on the side closer to the connector 5 do not have second portions 32 and third portions 33.

The case 4 of FIG. 4 includes a first region 4A, a second region 4B, a third region 4C, and an end portion 4D. The first region 4A is a region where the first portions 31 of the detection lines 30 are wired. The first region 4A is disposed on the first side Y1 with respect to the plurality of bus bars 2. The second region 4B is a region where the second portions 32 of the detection lines 30 are wired. The second region 4B is disposed on the second side Y2 with respect to the plurality of bus bars 2. The third region 4C is a region where the third portions 33 of the detection lines 30 are wired. The third region 4C is disposed between two adjacent bus bars 2.

All the detection lines 30 are connected to the connector 5 through the end portion 4D. The end portion 4D extends from the first region 4A and the second region 4B to the connector 5. In the bus bar module 1 of FIG. 4, the detection lines 30 are distributed to the first side Y1 and the second side Y2 with respect to the bus bars 2. As a result, the concentration of the electric wires in the region adjacent to the bus bars 2 is mitigated. In addition, the third portions 33 are each wired between two bus bars 2. As a result, the electric wire length is shortened as compared with a configuration in which the third portions 33 detour outward of the first bus bar group 21.

The flat wiring member 3 may be a flat wiring member different from the flexible printed circuit. The flat wiring member 3 may be, for example, a flat cable such as a ribbon cable. In the flat cable, a coating covering the plurality of detection lines 30 may be integrated in the vicinity of the connector 5. In the flat cable, in a portion where the predetermined detection lines 30x are arranged, the coating covering the predetermined detection lines 30x may be separated from the other portion of the coating.

As described above, the bus bar module 1 of the present embodiment includes bus bar groups 21 and 22 and a plurality of detection lines 30. Each of the bus bar groups 21 and 22 includes a plurality of bus bars 2 arranged at intervals along an arrangement direction X. The plurality of detection lines 30 are connected to the bus bars 2 of the bus bar groups 21 and 22. At least one detection line 30 among the plurality of detection lines 30 has a first portion 31, a second portion 32, and a third portion 33. The third portions 33 is wired between two adjacent bus bars 2 to connect the first portion 31 and the second portion 32.

The first portion 31 is wired on a first side Y1 with respect to the bus bar groups 21 and 22 in a width direction Y that is orthogonal to the arrangement direction X when the bus bar groups 21 and 22 are viewed in a plan view. The second portion 32 is wired on a second side Y2 in the width direction Y with respect to the bus bar groups 21 and 22. In the bus bar module 1 of the present embodiment, since at least some of the detection lines 30 have second portion 32 and third portion 33, the overcrowding of the detection lines 30 is suppressed. In addition, since the third portion 33 is wired between the two bus bars 2, the reduction of the size and weight of the bus bar module 1 is realized.

The detection lines 30 form, for example, a circuit pattern of a flexible printed circuit. The flexible printed circuit includes a first region 3A, a second region 3B, and a third region 3C. The first region 3A is a region where the first portion 31 of the detection lines 30 is formed. The second region 3B is a region where the second portion 32 of the detection lines 30 is formed. The third region 3C is a region where the third portion 33 of the detection lines 30 is formed. With such a configuration, the size of the flexible printed circuit can be reduced.

The bus bar module 1 may include a plurality of chip fuses 6 mounted on the flexible printed circuit and connected to the bus bars 2 of the bus bar groups 21 and 22. In this case, the plurality of chip fuses 6 may be arranged in a line along the arrangement direction X, and may be arranged on one side in the width direction Y with respect to the bus bar groups 21 and 22.

With such an arrangement of the chip fuses 6, the size of the flexible printed circuit in the width direction Y can be reduced. For example, in the bus bar module 1 of FIG. 1, the first fuse group 61 is arranged in a line on the first side Y1 with respect to the first bus bar group 21.

As a comparative example, it is assumed that some chip fuses 6 of the first fuse group 61 are arranged on the second side Y2 with respect to the first bus bar group 21. In the arrangement of the comparative example, the second portions 32 of the detection lines 30 are displaced toward the second side Y2 from the arrangement of FIG. 1 in order to bypass the chip fuses 6. As a result, the width of the second region 3B of the flat wiring member 3 increases. In contrast, in the bus bar module 1 of the present embodiment, since the chip fuses 6 are arranged on the same side with respect to the bus bar groups 21 and 22, the size of the flexible printed circuit can be reduced.

Note that the shape of the flat wiring member 3 and the shape of the case 4 are not limited to the shapes exemplified in the embodiments. The number and shape of the bus bars 2 included in the bus bar module 1 are not limited to the number and shape exemplified in the embodiments.

The embodiments disclosed above can be carried out in an appropriate combination.

In the bus bar module according to the present embodiment, at least one detection line has a first portion, a second portion, and a third portion wired between two adjacent bus bars to connect the first portion and the second portion. The first portion is wired on a first side with respect to the bus bar group in a width direction orthogonal to the arrangement direction when the bus bar group is viewed in a plan view, and the second portion is wired on a second side with respect to the bus bar group in the width direction. The bus bar module according to the present embodiment can suppress the overcrowding of the detection lines.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A bus bar module comprising:
a bus bar group including a plurality of bus bars arranged at intervals along an arrangement direction; and
a plurality of detection lines connected to the bus bars of the bus bar group, wherein
at least one detection line among the plurality of detection lines includes a first portion, a second portion, and a third portion wired between two adjacent ones of the bus bars to connect the first portion and the second portion,
the first portion is wired on a first side with respect to the bus bar group in a width direction orthogonal to the arrangement direction when the bus bar group is viewed in a plan view, and
the second portion is wired on a second side with respect to the bus bar group in the width direction.

2. The bus bar module according to claim 1, wherein
the plurality of detection lines form a circuit pattern of a flexible printed circuit, and
the flexible printed circuit includes a first region where the first portion of the detection line is formed, a second region where the second portion of the detection line is formed, and a third region where the third portion is formed.

3. The bus bar module according to claim 2, further comprising:
a plurality of chip fuses mounted on the flexible printed circuit and connected to the bus bars of the bus bar group, wherein
the plurality of chip fuses are arranged in a line along the arrangement direction, and is arranged on one side in the width direction with respect to the bus bar group.
